(19) United States
(12) Patent Application Publication
(10) Pub. No.: US 2017/0131826 A1
(43) Pub. Date: May 11, 2017

(54) METHOD AND DEVICE FOR OPERATING UPON NO RESPONSE OF TOUCH SCREEN

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Guoshuan HAN, Beijing (CN)

(21) Appl. No.: 15/219,385

(22) Filed: Jul. 26, 2016

Related U.S. Application Data
(63) Continuation of application No. PCT/CN2016/082913, filed on May 20, 2016.

(30) Foreign Application Priority Data
Nov. 6, 2015 (CN) 201510758287.9

(51) Int. Cl. G06F 3/041; G10L 15/22; G06F 3/044

(52) U.S. Cl. CPC G06F 3/0416; G06F 3/044; G10L 15/22; G10L 2015/223

(57) ABSTRACT

The disclosure provides a method for operating upon no response of a touch screen, the method applicable to a terminal device with the touch screen, the method including: detecting, by the terminal device, whether the touch screen currently responds; and if the touch screen doesn't respond, then starting, by the terminal device, a first preset operating mode so that the terminal device performs a corresponding function in the first preset operating mode. With the disclosure, even if the touch screen doesn't respond, then the terminal device can be operated in a basic mode to thereby execute a corresponding operation instruction so as to avoid some unnecessary inconvenience from being brought to a user if the touch screen doesn't respond.

This application is a continuation of International Application No. PCT/CN2016/082913, filed on May 20, 2016, designating the United States, and claiming the benefit of Chinese Patent Application No. 201510758287.9, filed with the Chinese Patent Office on Nov. 6, 2015 and entitled “Method and device for operating upon no response of touch screen”, which is hereby incorporated by reference in its entirety.

### TECHNICAL FIELD

The present disclosure relates to the field of control technologies, and particularly to a method and device for operating upon no response of a touch screen.

### BACKGROUND

Existing smart mobile phones are operated in a basic mode with touch screens on which the mobile phones are unlocked, a call is made, a call is accepted, information is viewed, etc., where their users can accept a call, play game, and conduct a series of other activities by sliding their fingers over the touch screens, and thus can be provided with better operating experiences than functionalized mobile phones.

The inventors have identified during making of the disclosure at least the following problems in the prior art:

If the touch screen being damaged accidentally is not responding, then the mobile phone may not receive any operation information from the user to thereby execute a corresponding operation instruction, e.g., to be unlocked, to accept or make a call, etc., so that the user may miss the important call, fail to view the information in a timely manner, or fail to conduct another operation, thus bringing some unnecessary inconvenience to the user.

### SUMMARY

Embodiments of the disclosure provide a method and device for operating upon no response of a touch screen, where a terminal device starts a first preset operating mode upon detecting currently no response of a touch screen so that the terminal device performs a corresponding function in the first preset operating mode, and in this way, even if the touch screen doesn't respond, then the terminal device can be operated in a basic mode to thereby execute a corresponding operation instruction so as to avoid some unnecessary inconvenience from being brought to a user if the touch screen doesn't respond.

An embodiment of the disclosure provides a method for operating upon no response of a touch screen, the method being applicable to a terminal device with the touch screen, the method including:

detecting, by the terminal device, whether the touch screen currently responds; and

when the touch screen doesn't respond, then starting, by the terminal device, a first preset operating mode so that the terminal device performs a corresponding function in the first preset operating mode.

An embodiment of the disclosure provides a terminal device, including:

at least one processor; and

a memory communicably connected with the at least one processor for storing instructions executable by the at least one processor,

wherein execution of the instructions by the least one processor causes the least one processor to:

detect whether the touch screen currently responds; and

when the touch screen doesn't respond, to start a first preset operating mode so that the terminal device performs a corresponding function in the first preset operating mode

In the embodiments of the disclosure, the terminal device starts the first preset operating mode upon detecting currently no response of the touch screen so that the terminal device performs the corresponding function in the first preset operating mode, and in this way, even if the touch screen doesn't respond, then the terminal device can be operated in a basic mode to thereby execute the corresponding operation instruction so as to avoid some unnecessary inconvenience from being brought to a user if the touch screen doesn't respond.

### BRIEF DESCRIPTION OF THE DRAWINGS

In order to make the technical solutions according to the embodiments of the disclosure or in the prior art more apparent, the drawings to which a description of the embodiments or the prior art refers will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 is a flow chart of a method for operating upon no response of a touch screen according to an embodiment of the disclosure;

FIG. 2 is a schematic structural diagram of a terminal device according to an embodiment of the disclosure; and

FIG. 3 is a schematic structural diagram of another terminal device according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

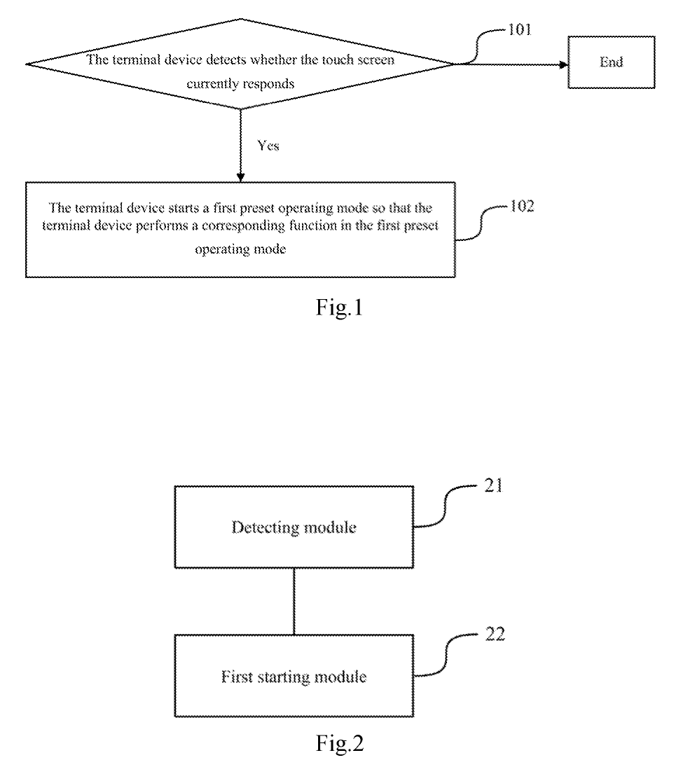

In order to enable a user to operate a terminal device in a basic mode even if a touch screen being damaged doesn't respond, an embodiment of the disclosure provides a method for operating upon no response of a touch screen, and with this method, even if the touch screen of the terminal device doesn't respond, then the user can be provided with basic function of accepting and making a call, transmitting, receiving, and viewing information, etc. Particularly as illustrated in FIG. 1 which is a flow chart of a method for operating upon no response of a touch screen, the method is applicable to a terminal device with the touch screen, and can include the following steps:

In the step 101, the terminal device detects whether the touch screen currently responds.

If the touch screen doesn't respond, then the flow proceeds to the step 102; otherwise, the flow ends.

Particularly for the terminal device being operated with the touch screen, if the touch screen doesn't respond (if the touch screen of the terminal device is damaged, then the terminal device can not receive sliding operation information of a user, or the touch screen of the terminal device can receive the sliding operation information of the user, but can not convert the sliding operation information of the user into a corresponding electric signal transmitted to the terminal device), then the terminal device needs to get timely knowledge of this, which can be known in at least the following schemes:

In a first scheme, when the terminal device receives information, then the terminal device detects whether the touch screen currently responds.

Particularly when the terminal device receives information, then the user typically needs to respond accordingly, for example, when the terminal device is a mobile phone, then the received information can be an incoming call or a short message, and when the received information is an incoming call, then the user operates to accept the call timely, and at this time, the terminal device needs to detect whether the touch screen of the current terminal device responds; and with the method above, if the user needs to respond accordingly in response to the received information, then the user needs to get timely knowledge of whether the touch screen of the terminal device currently responds, and thus can operate accordingly dependent upon to a real condition.

Here the received information can be an incoming call, a short message, an alert, operation feedback information, etc., and the terminal device can be any device operating with a touch screen, e.g., a mobile phone, a tablet computer, etc.

In a second scheme, the terminal device detects whether the touch screen currently responds, at a preset periodicity of time.

Since the touch screen doesn't response accidentally, typically for a period of time, that is, the touch screen may not become active immediately, the terminal device can detect whether the touch screen currently responds, at the preset periodicity of time, which can be 1 hour, 3 hours, etc. With the method above, a corresponding operating strategy can be prepared for the user before the user operates the terminal device with the touch screen so that the user can perform a timely operation on the terminal device, thus shortening a delay in operating by the user the terminal device.

Either the first scheme or the second scheme can be applied separately, or both the first scheme and the second scheme can be applied together, for example, after the terminal device detects periodically whether the touch screen currently responds, the terminal device detects this again upon reception of information; and both the first scheme and the second scheme can be applied together for such a benefit that if the touch screen responds in some detection periodicity, then the terminal device can resume the respective functions timely. The first scheme or the second scheme or a combination of both can be applied particularly under a real condition. Of course, other detection schemes than the two detection schemes above will be possible, and the disclosure is intended for timely detection of whether the touch screen responds, all the feasible schemes of timely detection of whether the touch screen will fall into the scope of the disclosure as claimed.

The terminal device detects whether the touch screen currently responds, particularly as follows:

The terminal device obtains a current capacitance value of the touch screen;

The terminal device determines whether the capacitance value lies in a preset range; and

If the capacitance value lies in the preset range, then the terminal device starts a communication detection function of the touch screen so that the terminal device sets up communication with the touch screen,

The terminal device determines whether preset information transmitted by the touch screen is received in a preset period of time, and

If the preset information transmitted by the touch screen is received in the preset period of time, then the terminal device determines that the touch screen responds, or

If the preset information transmitted by the touch screen is not received in the preset period of time, then the terminal device determines that the touch screen doesn't respond; or

If the capacitance value does not lie in the preset range, then the terminal device determines that the touch screen doesn't respond.

Particularly the terminal device can operate accordingly in response to the operation information of the user generally in the following two steps: in a first step, the touch screen of the terminal device obtains the operation information of the user, and in a second step, the touch screen converts the operation information into the corresponding electric signal transmitted to the terminal device, so the touch screen may make no response generally in the following two scenarios: in a first scenario, the touch screen of the terminal device can not obtain the operation information of the user, and in a second scenario, the touch screen can not transmit the electric signal to the terminal device, so the terminal device needs to detect at least twice whether the touch screen responds. In the first detection, the terminal device determines whether the current capacitance value of the touch screen lies in the preset range, so when the capacitance value of the touch screen doesn't lie in the preset range, the touch screen doesn't respond, and when the capacitance value lies in the preset range, then it may indicate that the touch screen can obtain the operation information of the user, so the terminal device will detect for the second time whether the terminal device can receive the electric signal transmitted by the touch screen; and if the capacitance value does not lie in the preset range, then it will indicate that the touch screen can not obtain the operation information of the user, and at this time, the touch screen doesn't respond. In the second detection, then since the touch screen transmits the electric signal to the terminal device by communicating therewith, the terminal device starts the communication detection function of the touch screen so that the terminal device sets up communication with the touch screen, and particularly a Central Processing Unit (CPU) sets up communication with an Integrated Circuit (IC), and if the terminal device does not receive the preset information transmitted by the touch screen in the preset period of time, then it can indicate that the touch screen can not transmit the electric signal to the terminal device, that is, the CPU does not receive the preset information transmitted by the IC in the preset period of time, and at this time, the touch screen doesn't respond either. Thus the terminal device can determine whether the touch screen thereof responds, by detecting for the first time and the second time.

The steps in the detection process above can be performed under a real condition, that is, firstly the detection can be performed to determine whether the touch screen is communicating with the terminal device, and then the detection can be performed to determine whether the capacitance value of the touch screen lies in the threshold range, or of course, both of the detections can be performed in parallel; and the disclosure is intended to detect whether the touch screen is currently responding, so all the schemes to detect whether the touch screen currently responds will fall into the scope of the disclosure as claimed.

The terminal device determines whether the touch screen responds by determining whether the preset information transmitted by the touch screen is received, because that if a part of the touch screen is active, whereas the remaining part thereof is inactive, then the touch screen still can obtain a part of the operation information of the user, and if the terminal device at this time can receive the electric signal transmitted by the touch screen, then the terminal device will determine by mistake that the touch screen responds, but the touch screen at this time may seriously hinder the operating the user, so the terminal device determines from the preset information whether the touch screen responds.

In the step 102, the terminal device starts a first preset operating mode so that the terminal device performs a corresponding function in the first preset operating mode.

The terminal device performs the corresponding function in the first preset operating mode particularly as follows:

The terminal device receives first button operation information of the user;

The terminal device determines whether the first button operation information satisfies a preset condition according to the first preset operating mode; and

If so, then the terminal device performs the corresponding function according to the first button operation information.

Particularly the first button operation information can be a preset combination of buttons, or can be a single button; the first preset operating mode can be the preset combination of buttons, and a function corresponding to the combination of buttons, or can be the single button, and a function corresponding to the single button; and the corresponding function being performed can be particularly a function which can be performed with a sliding operation by the user operating on the touch screen, e.g., of the terminal device is a mobile phone, then the function can be accepting a call, unlocking the terminal device, starting an application of the terminal device, etc.

The disclosure is intended to perform the corresponding function even if the touch screen doesn't respond, so all the schemes in which the corresponding function can be performed if the touch screen doesn't respond, e.g., the terminal device can perform the corresponding function using an image or a gesture, will fall into the scope of the disclosure as claimed.

If the terminal device performs a voice function, then the method further includes:

The terminal device generates a corresponding command from received first voice information of the user under a preset voice rule;

The terminal device enables a corresponding function in response to the command;

The terminal device generates corresponding information from second voice information of the user;

The terminal device receives second button operation information of the user;

The terminal device determines whether the second button information satisfies a preset condition according to a second preset operating mode; and

If so, then the terminal device operates accordingly according to the generated information.

Particularly when the terminal device is a smart phone or a tablet computer, then the voice function in the terminal device can obtain the voice information of the user, enable the corresponding function, and accept the corresponding input, and then determine according to the second preset operating mode whether the second button operation information satisfies the preset condition, and if so, then the terminal device can operate accordingly. For example, when the user needs to make a call, then the user transmits voice information of the call to the terminal device under a preset voice rule, and the terminal device enables a call function according to the voice information; and then the user transmits digital voice information corresponding to the call to the terminal device, the terminal device performs the digital input after obtaining the digital voice information, the user further issues an instruction to make the call, using a preset combination of buttons or a single button, and the terminal device can make the call using digits in the digital voice information. Of course, the first voice information can alternatively be a voice command to enable a short messaging function, and the second voice information can alternatively be text voice information, letter voice information, etc.; and after the terminal device performs the text or the letter input according the second voice information, the user can compose a corresponding instruction using a preset combination of buttons or a single button for short messaging, then the terminal device can transmit the text information or the letter information in response to the instruction.

The second button operation information can be a preset combination of buttons, or can be a single button; and the second preset operating mode can be the preset combination of buttons, and a function corresponding to the combination of buttons, or can be the single button, and a function corresponding to each button.

The first button operation information may or may not be arranged in the same way as the second button operation information, and the same button of combinations or single button represents different functions in the first preset operating mode and the second preset operating mode.

When the terminal device performs a voice function, then the user can make an input under a preset voice rule to enable the terminal device to perform a corresponding operation. For example, if the user is going to make a call, then the user can make a digital input via voice, and then control the call to be made, via preset voice.

In the embodiment of the disclosure, the terminal device starts the first preset operating mode upon detecting currently no response of the touch screen so that the terminal device performs the corresponding function in the first preset operating mode, and in this way, even if the touch screen is not responding, then the terminal device can be operated in a basic mode to thereby execute the corresponding operation instruction so as to avoid some unnecessary inconvenience from being brought to a user if the touch screen doesn't respond.

Based upon the same inventive idea as the method above, an embodiment of the disclosure further provides a terminal device operated with a touch screen as illustrated in FIG. 2, where the terminal device includes:

A detecting module 21 is configured to detect whether the touch screen currently responds; and

A first enabling module 22 is configured, if the touch screen doesn't respond, to start a first preset operating mode so that the terminal device performs a corresponding function in the first preset operating mode.

The detecting module 21 is configured:

Upon reception information by the terminal device, to detect whether the touch screen currently responds; and

To detect whether the touch screen currently responds, at a preset periodicity of time.

The detecting module 21 is further configured:

To obtain a current capacitance value of the touch screen;

To determine whether the capacitance value lies in a preset range; and

If the capacitance value lies in the preset range, then the terminal device starts a communication detection function of the touch screen so that the terminal device sets up communication with the touch screen,

To determine whether preset information transmitted by the touch screen is received in a preset period of time, and

If the preset information transmitted by the touch screen is received in the preset period of time, to determine that the touch screen responds, or

If the preset information transmitted by the touch screen is not received in the preset period of time, then the terminal device determines that the touch screen doesn't respond; or

If the capacitance value does not lie in the preset range, to determine that the touch screen doesn't respond.

The device further includes:

A first receiving module is configured to receive first button operation information of a user;

A first determining module is configured to determine whether the first button operation information satisfies a preset condition according to the first preset operating mode; and

A first performing module is configured, if the first button operation information satisfies a preset condition, to perform the corresponding function according to the first button operation information.

The device further includes:

A first generating module is configured, if the terminal device performs a voice function, to generates a corresponding command from received first voice information of the user under a preset voice rule;

A second enabling module is configured to enable a corresponding function in response to the command;

A second generating module is configured to generate corresponding information from second voice information of the user;

A second receiving module is configured to receive second button operation information of the user;

A second determining module is configured to determine whether the second button information satisfies a preset condition according to a second preset operating mode; and

A performing module is configured, if the second button information satisfies a preset condition, to operate accordingly according to the generated information.

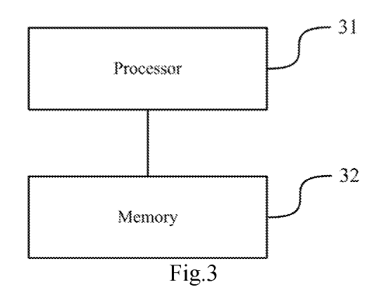

Based upon the same inventive idea as the method above, an embodiment of the disclosure further provides a terminal device operated with a touch screen as illustrated in FIG. 3, where the terminal device includes: at least one processor 32; and a memory 31 communicably connected with the at least one processor for storing instructions executable by the at least one processor.

Where execution of the instructions by the least one processor 31 causes the least one processor to:

detect whether the touch screen currently responds; and

when the touch screen doesn't respond, to start a first preset operating mode so that the terminal device performs a corresponding function in the first preset operating mode.

In at least one embodiment, the execution of the instructions by the least one processor causes the least one processor to: upon reception of information by the terminal device, detect whether the touch screen currently responds; or detect whether the touch screen currently responds, at a preset periodicity of time.

In at least one embodiment, the execution of the instructions by the least one processor further causes the least one processor to:

obtain a current capacitance value of the touch screen;

determine whether the capacitance value lies in a preset range; and

when the capacitance value lies in the preset range, then the terminal device enables a communication detection function of the touch screen so that the terminal device sets up communication with the touch screen,

determine whether preset information transmitted by the touch screen is received in a preset period of time, and

when the preset information transmitted by the touch screen is received in the preset period of time, determine that the touch screen responds, or

when the preset information transmitted by the touch screen is not received in the preset period of time, determine that the touch screen doesn't respond; or

when the capacitance value does not lie in the preset range, determine that the touch screen doesn't respond.

In at least one embodiment, the execution of the instructions by the least one processor further causes the least one processor to:

receive first button operation information of a user;

determine whether the first button operation information satisfies a preset condition according to the first preset operating mode; and

when the first button operation information satisfies with the preset condition, perform the corresponding function according to the first button operation information.

In at least one embodiment, the execution of the instructions by the least one processor further causes the least one processor to:

when the terminal device performs a voice function, generates a corresponding command from received first voice information of the user under a preset voice rule;

enable a corresponding function in response to the command;

generate corresponding information from second voice information of the user;

receive second button operation information of the user;

determine whether the second button information satisfies a preset condition according to a second preset operating mode; and

when the second button information satisfies the preset condition, to operate accordingly according to the generated information.

In the embodiment of the disclosure, the terminal device starts the first preset operating mode upon detecting currently no response of the touch screen so that the terminal device performs the corresponding function in the first preset operating mode, and in this way, even if the touch screen doesn't respond, then the terminal device can be operated in a basic mode to thereby execute the corresponding operation instruction so as to avoid some unnecessary inconvenience from being brought to a user if the touch screen doesn't respond.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for operating upon no response of a touch screen, the method applicable to a terminal device with the touch screen, the method comprising:
detecting, by the terminal device, whether the touch screen currently responds; and
when the touch screen doesn't respond, then starting, by the terminal device, a first preset operating mode so that the terminal device performs a corresponding function in the first preset operating mode.

2. The method according to claim 1, wherein detecting, by the terminal device, whether the touch screen currently responds comprises:
upon reception of information, detecting, by the terminal device, whether the touch screen responds; or
detecting, by the terminal device, whether the touch screen currently responds at a preset periodicity of time.

3. The method according to claim 2, wherein detecting, by the terminal device, whether the touch screen currently responds comprises:
obtaining, by the terminal device, a current capacitance value of the touch screen;
determining, by the terminal device, whether the capacitance value lies in a preset range; and
when the capacitance value lies in the preset range, then:
enabling, by the terminal device, a communication detection function of the touch screen so that the terminal device sets up communication with the touch screen,
determining, by the terminal device, whether preset information transmitted by the touch screen is received in a preset period of time, and
when the preset information transmitted by the touch screen is received in the preset period of time, then determining, by the terminal device, that the touch screen responds, or
when the preset information transmitted by the touch screen is not received in the preset period of time, then determining, by the terminal device, that the touch screen doesn't respond; or
when the capacitance value does not lie in the preset range, then determining, by the terminal device, that the touch screen doesn't respond.

4. The method according to claim 1, wherein the terminal device performing a corresponding function in the first preset operating mode comprises:
receiving, by the terminal device, first button operation information of a user;
determining, by the terminal device, whether the first button operation information satisfies a preset condition according to the first preset operating mode; and
when the first button operation information satisfies with the preset condition, then performing, by the terminal device, the corresponding function according to the first button operation information.

5. The method according to claim 4, wherein when the terminal device performs a voice function, then the method further comprises:
generating, by the terminal device, a corresponding command from received first voice information of the user under a preset voice rule;
enabling, by the terminal device, a corresponding function in response to the command;
generating, by the terminal device, corresponding information from second voice information of the user;
receiving, by the terminal device, second button operation information of the user;
determining, by the terminal device, whether the second button information satisfies a preset condition according to a second preset operating mode; and
when the second button information satisfies the preset condition, then operating, by the terminal device, accordingly according to the generated information.

6. A terminal device, comprising:
at least one processor; and
a memory communicably connected with the at least one processor for storing instructions executable by the at least one processor,
wherein execution of the instructions by the least one processor causes the least one processor to:
detect whether the touch screen currently responds; and
when the touch screen doesn't respond, to start a first preset operating mode so that the terminal device performs a corresponding function in the first preset operating mode.

7. The device according to claim 6, wherein execution of the instructions by the at least one processor causes the at least one processor to:
upon reception of information by the terminal device, detect whether the touch screen currently responds; or
detect whether the touch screen currently responds, at a preset periodicity of time.

8. The device according to claim 7, wherein execution of the instructions by the at least one processor further causes the at least one processor to:
obtain a current capacitance value of the touch screen;
determine whether the capacitance value lies in a preset range; and
when the capacitance value lies in the preset range, then the terminal device enables a communication detection function of the touch screen so that the terminal device sets up communication with the touch screen,
determine whether preset information transmitted by the touch screen is received in a preset period of time, and
when the preset information transmitted by the touch screen is received in the preset period of time, determine that the touch screen responds, or
when the preset information transmitted by the touch screen is not received in the preset period of time, determine that the touch screen doesn't respond; or
when the capacitance value does not lie in the preset range, determine that the touch screen doesn't respond.

9. The device according to claim 6, wherein execution of the instructions by the at least one processor further causes the at least one processor to:
receive first button operation information of a user;
determine whether the first button operation information satisfies a preset condition according to the first preset operating mode; and
when the first button operation information satisfies with the preset condition, perform the corresponding function according to the first button operation information.

10. The device according to claim 9, wherein execution of the instructions by the at least one processor further causes the at least one processor to:
when the terminal device performs a voice function, generates a corresponding command from received first voice information of the user under a preset voice rule;
enable a corresponding function in response to the command;
generate corresponding information from second voice information of the user;
receive second button operation information of the user;
determine whether the second button information satisfies a preset condition according to a second preset operating mode; and
when the second button information satisfies the preset condition, to operate accordingly according to the generated information.
